(19) United States
(12) Patent Application Publication
(10) Pub. No.: US 2006/0037449 A1
(43) Pub. Date: Feb. 23, 2006

(54) Paper cutting apparatus and method of producing same

(75) Inventor: Andre A. Lavallee, Charlton, MA (US)

Correspondence Address: BROOKS KUSHMAN P.C., 1000 TOWN CENTER, TWENTY-SECOND FLOOR, SOUTHFIELD, MI, 48075, US

(73) Assignee: L & P Paper, Inc., Charlton, MA (US)

(21) Appl. No.: 10/919,926

(22) Filed: Aug. 17, 2004

(51) Int. Cl. B26D 3/00; B26D 7/00

(52) U.S. Cl. 83/54; 83/649; 83/928; 83/937

(57) ABSTRACT

The present invention provides a horizontal paper cutter that includes a pair of movable arms, each of which has a spindle attached thereto. The spindles are generally aligned with each other, and are configured to engage respective ends of a horizontally oriented paper roll. A pair of actuators are used to move the arms upward, thereby lifting the paper roll off the floor. One of the spindles is operable to rotate the paper roll after the paper roll is lifted off the floor. A saw that is initially above the paper roll is moved downward into the paper to effect removal of a damaged end of the roll.

### BACKGROUND OF THE INVENTION

1. Field of the Invention

The present invention relates to a paper cutting apparatus and a method of producing a paper cutting apparatus.

2. Background Art

In the paper industry, large rolls of paper are manufactured by continuously winding the paper around a core. Depending on how the paper roll is handled, one or both of the ends of the paper roll can become damaged. One way for such damage to occur is when the paper roll is store vertically, such that one end rests on the floor. If the floor becomes wet, the paper and the roll will absorb the moisture and become stained and unusable. Usually, only that portion of the paper roll in contact with the floor will become unusable, while the rest of the paper on the roll is undamaged.

Although paper rolls may be stored vertically, such that a longitudinal axis of the roll is approximately perpendicular to the floor, paper rolls may also be stored horizontally. In such cases, the longitudinal axis of the paper roll is approximately parallel to the floor. Paper rolls as used in industry may be three to five feet in diameter and about four feet in length. As such, the paper rolls are heavy and bulky. Thus, when it is necessary to remove a damaged end from a roll of paper, it may be very inconvenient to reorient a horizontal paper roll to a vertical position to accommodate a vertical cutting machine.

One attempt to deal with this problem is described in U.S. Pat. No. 6,269,719 issued to Easton et al. on Aug. 7, 2001. Easton et al. describes a roll-trimming machine that is used to cut damaged ends off rolls of paper. The machine is configured to accommodate a horizontally oriented paper roll, such that the paper roll need not be reoriented vertically to perform the cut. One limitation of the roll-trimming machine of Easton et al., is that the paper roll is held in a cradle that is located some distance from the floor. Thus, a large, heavy roll of paper must be lifted some distance from the floor and placed in the cradle before it can be cut. Then, because it is resting on a cradle, the paper roll cannot be easily rotated. Therefore, the roll-trimming machine described in Easton et al. rotates the saw blade around the circumference of the paper roll, rather than merely spinning the paper roll on its longitudinal axis.

Therefore, a need exists for a paper cutting apparatus that can engage a roll of paper sitting horizontally on a floor, and can spin the paper roll to eliminate the need to rotate a saw around the circumference of the roll.

### SUMMARY OF THE INVENTION

Accordingly, the present invention provides a paper cutting apparatus that can engage a roll of paper oriented horizontally on the floor, and can rotate the paper roll about its longitudinal axis to facilitate cutting of the paper.

The present invention also provides a paper cutting apparatus that can engage a roll of paper horizontally oriented on the floor, and can lift the paper roll off the floor to further facilitate cutting.

The present invention further provides an apparatus for cutting a horizontally oriented paper roll. The apparatus includes a base including a movable arm. The arm has a spindle attached thereto that is configured to engage an end of the horizontally oriented paper roll. The spindles is operable to rotate the paper roll about a longitudinal axis. An actuator cooperates with the arm for selectively adjusting the height of the spindle. The actuator is operable to lift the paper roll off a resting surface to position the paper roll for cutting when the spindle is engaged with the end of the paper roll. A vertical support is provided proximate the base, and a blade is supported by the vertical support. The blade is movable in a plane generally perpendicular to the longitudinal axis, and is movable into the paper roll for cutting the paper roll.

The invention also provides a horizontal paper cutter including a base including a pair of movable arms. Each of the arms has a spindle attached thereto, and each of the spindles is generally aligned with the other spindle, and is configured to engage a respective end of a horizontally oriented paper roll. At least one of the spindles is operable to rotate the paper roll about a longitudinal axis. Each cylinder of a pair of hydraulic cylinders cooperates with a respective arm for selectively adjusting the height of a respective spindle to a predetermined height. The cylinders are operable to lift the paper roll off a resting surface to position the paper roll for cutting when the spindles are engaged with the ends of the paper roll. A vertical support is provided proximate the base, and a rotary saw is supported by the vertical support. The rotary saw is movable along the length of the vertical support, and is movable into the paper roll for cutting the paper roll.

The invention further provides a method of producing a horizontal paper cutter from a paper roll stand. The stand includes a base and a pair of actuators. The base includes a pair of movable arms, and each of the actuators cooperates with a respective arm for selectively adjusting the height of at least a portion of the respective arm. The method includes attaching a spindle to each of the arms such that the spindles are in general alignment with each other. Each of the spindles is configured to engage a respective end of a horizontally oriented paper roll. A maximum extension of the actuators is set to a predetermined fixed distance, thereby facilitating lifting of the paper roll to a predetermined fixed height for cutting. A vertical support is provided proximate the base, and a blade is supported on the vertical support. The blade is movable along a length of the vertical support, thereby facilitating movement of the blade into the paper roll engaged by the spindles.

### BRIEF DESCRIPTION OF THE DRAWINGS

FIG. 1 is a perspective view of a horizontal paper cutter in accordance with the present invention;

FIG. 2 is a side view of a portion of the paper cutter shown in FIG. 1;

FIG. 3 is a perspective view of the paper cutter shown in FIG. 1 as it engages a horizontally oriented paper roll; and

FIG. 4 is a perspective view of the paper cutter shown in FIG. 1, illustrating a saw used to cut paper from a paper roll.

### DESCRIPTION OF THE PREFERRED EMBODIMENT(S)

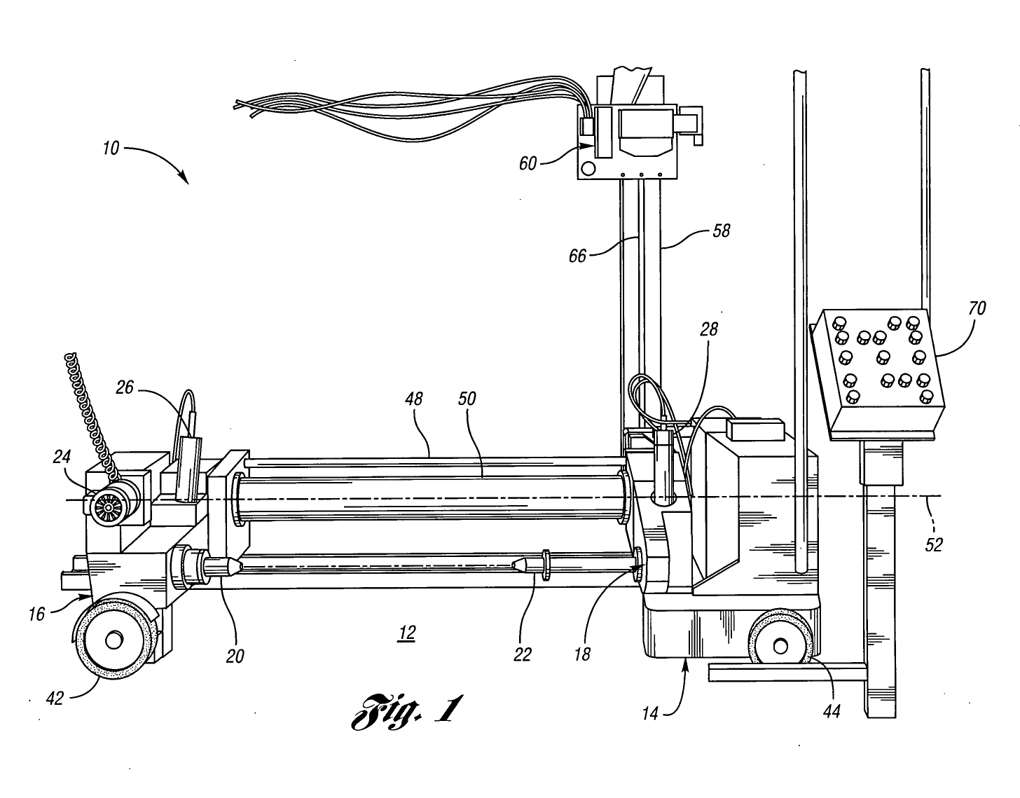

FIG. 1 shows a horizontal paper cutter 10 in accordance with the present invention. The paper cutter 10 is referred to as “horizontal” because it is configured to cut a roll of paper that has its longitudinal axis oriented approximately horizontally—i.e. approximately parallel to the floor 12. The paper cutter 10 includes a base 14 that includes a pair of movable arms 16, 18. The arms 16, 18 have spindles 20, 22 respectively attached thereto. As described more fully below, each of the spindles 20, 22 is generally aligned with the other spindle such that respective ends of a horizontally oriented paper roll may be engaged. Although the embodiment shown in FIG. 1 includes a pair of arms 16, 18 with spindles 20, 22, a paper cutter, such as the paper cutter 10, may have a single movable arm, and therefore, a single spindle to engage one end of a paper roll.

The spindle 20 is operable to rotate a paper roll about its longitudinal axis. In particular, an electric motor 24 is operable to rotate the spindle 20, which in turn rotates the paper roll about its longitudinal axis when the spindles are engaged with the ends of the paper roll. Of course, other types of torque producing devices—e.g., hydraulic motors—could be used to rotate the spindle 20. In the embodiment shown in FIG. 1, the spindle 22 is rotatable around its axis to accommodate rotation of a paper roll. If desired, a torque producing device, such as the motor 24, could be attached to the spindle 22, so that both of the spindles 20, 22 impart torque to a paper roll.

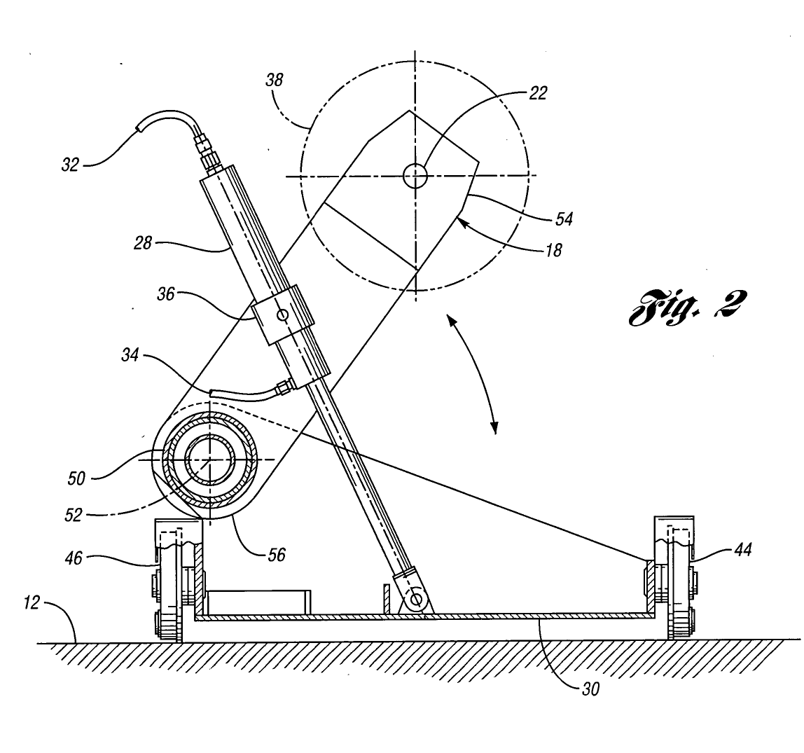

The paper cutter 10 also includes a pair of actuators, or hydraulic cylinders 26, 28. Although the actuators in the embodiment shown in FIG. 1 are hydraulic cylinders, other types of actuators—e.g., electric or pneumatic actuators—may be used. As best shown in FIG. 2, the hydraulic cylinder 28 is disposed between the arm 18 and a vertically stationary portion 30 of the base 14. Also as shown in FIG. 2, hydraulic hoses 32, 34 are attached to opposite ends of the cylinder 28, and selectively provide an inlet and an outlet for hydraulic fluid to and from the cylinder 28. The cylinder 28 is attached to the arm 18 at a sleeve 36. Thus, as the cylinder 28 is actuated, the arm 18 pivots and moves in accordance with the directional arrow shown in FIG. 2. Opposite the arm 18 and the cylinder 28, the arm 16 and cylinder 26 are similarly configured.

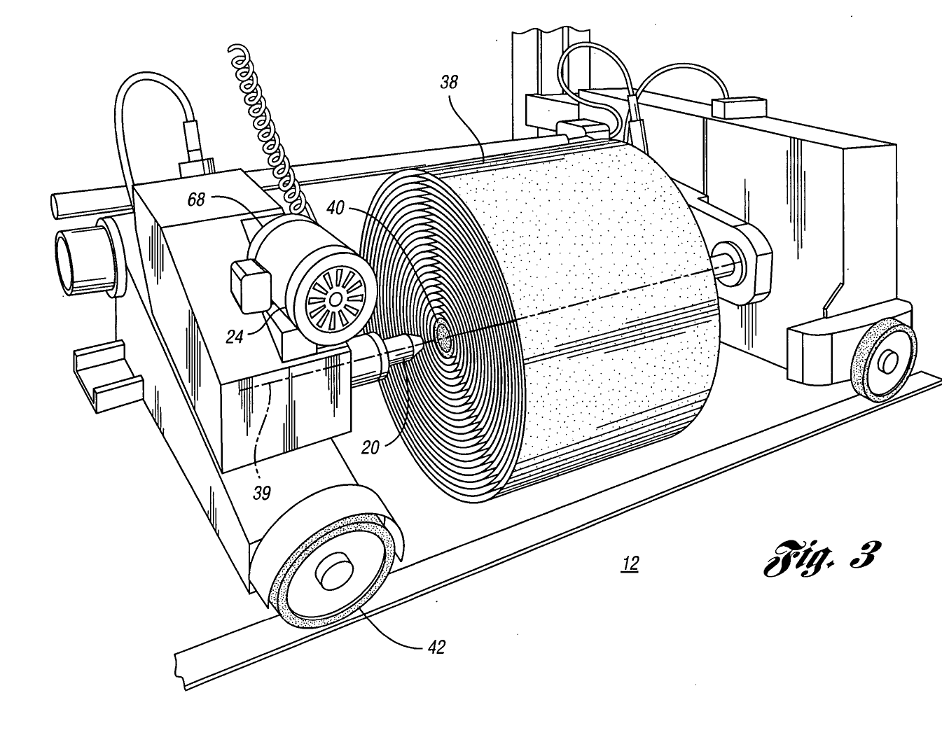

As the cylinders 26, 28 are actuated to lift the arms 16, 18, the respective spindles 20, 22 are also lifted. The movement of the spindles 20, 22 in this manner facilitates engagement with a paper roll that is resting on a horizontal surface, such as a floor. FIG. 3 shows a paper roll 38, defining a longitudinal axis 39, resting on the floor 12. The spindle 20 has been positioned to be in alignment with a core 40 of the paper roll 38. To facilitate engagement of the spindles 20, 22 with the paper roll 38, the base 14 is provided with wheels 42, 44, 46—see also FIGS. 1 and 2. It is understood that the base 14 includes four wheels, one of which is not visible in the drawing figures. The four wheels facilitate movement of the paper cutter 10 to various locations, thereby eliminating the need to move paper rolls to the paper cutter.

In order to engage the paper roll 38, the arm 16 and the spindle 20 are moved linearly toward the core 40. This may be accomplished by any method effective to move the spindle 20 into the core 40 to engage the paper roll 38. In the embodiment shown in FIGS. 1-3, linear movement of the arm 16 toward the paper roll 38 is facilitated by rotation of a power screw 48 disposed at the back of the base 14—see FIG. 1. Rotation of the power screw 48 may be effected by a torque producing device, for example, an electric or hydraulic motor. Thus, the paper cutter 10 easily facilitates engagement of the spindles 20, 22 with paper rolls of various lengths. The arms 16, 18 also move front-to-back to further facilitate engagement of the spindles 20, 22 with a paper roll.

Once the spindles 20, 22 are engaged with the respective ends of the paper roll 38, the hydraulic cylinders 26, 28 can be actuated to lift the paper roll 38 off the floor 12; this is shown in FIG. 2, where the paper roll 38 is illustrated in phantom. In order to consistently raise paper rolls to the same height for cutting, the cylinders 26, 28 are configured with a maximum extension set to a predetermined fixed distance. This facilitates lifting of the spindles 20, 22, and therefore any paper roll engaged with the spindles 20, 22, to a predetermined fixed height for cutting. This may be accomplished, for example, by disposing one or more spacers within the cylinders 26, 28 to limit their extension.

As best shown in FIG. 1, the base 14 includes a rail 50 that defines a rail axis 52. FIG. 2 shows the arm 18 including a first end 54, having the spindle 22 proximately attached thereto, and a second end 56 that cooperates with the rail 50 such that the arm 18 pivots about the rail axis 52 when the hydraulic cylinder 28 is actuated. It is understood that the arm 16 on the other end of the paper cutter 10 is similarly configured. In addition, each of the arms 16, 18 is keyed to the rail 50 such that the arms 16, 18 pivot about the rail axis 52 synchronously, thereby keeping the spindles 20, 22 generally aligned as the height of the spindles 20, 22 is adjusted.

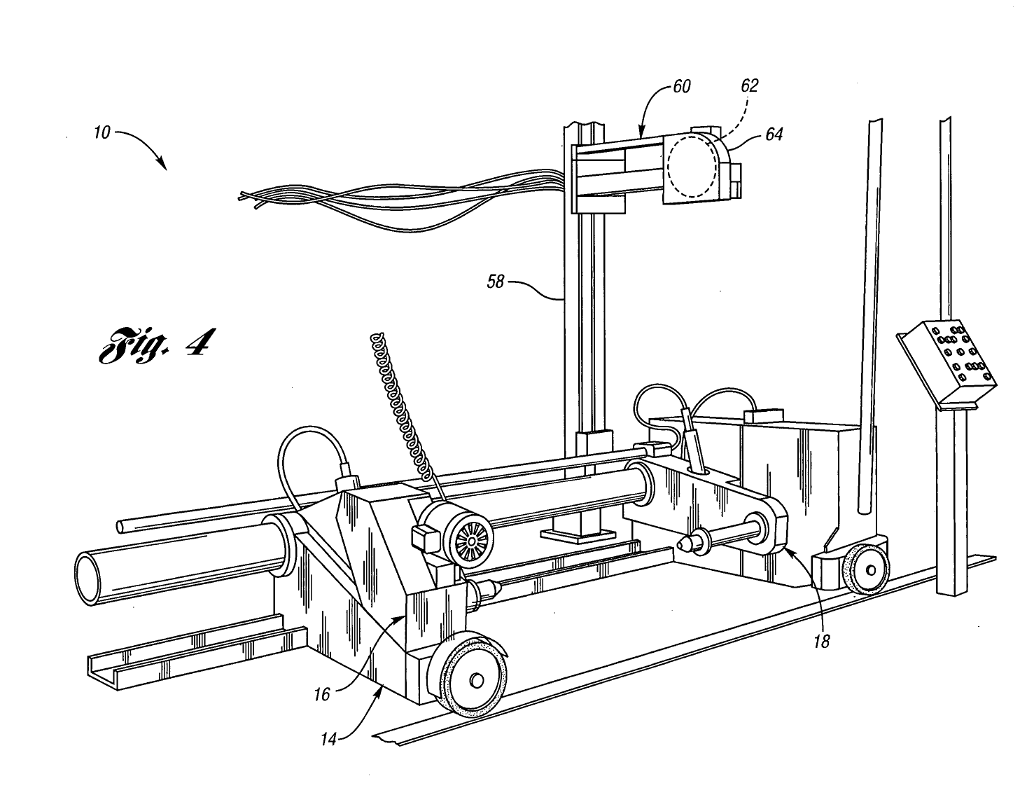

As best shown in FIG. 4, the paper cutter 10 also includes a vertical support 58 disposed proximate the base 14. Supported on the vertical support 58 is a rotary saw 60. The saw 60 includes a circular blade 62 that is shown as a hidden line below a blade guard 64. The saw 60 rotates the saw blade 62, and is movable linearly along a length of the support 58. Thus, the saw 60, and the blade 62, are movable into a paper roll, such as the paper roll 38, for cutting radially into the paper roll. In the embodiment shown in FIGS. 1 and 4, a chain drive, including a chain 66, is used to effect movement of the saw 60 up and down. Of course, any mechanism effective to move the saw 60 up and down—e.g., a power screw, a hydraulic cylinder, etc.—may be used. As the blade 62 moves into a paper roll and begins to cut the paper roll, the diameter of the paper in contact with the blade 62 is reduced. That is, as the blade 62 cuts into the paper roll it will cut paper on a roll whose diameter is steadily decreasing. Thus, it may be beneficial to vary the speed of the saw 60 as it moves into the paper roll. In addition, it may further be beneficial to vary the rotational speed of the paper roll. In order to facilitate removal of the paper from the roll, a radial cut is made in the end of the roll prior to engaging the blade 62. The radial cut is made to a depth approximately equal to the width of the trim portion—i.e., the portion of the paper roll being removed.

Turning to FIG. 3, a gear box 68 is shown disposed between the motor 24 and the spindle 20. The gear box 68 contains a gear set which is capable of providing multiple gear ratios to vary the speed of the spindle 20, even if the speed of the motor 24 is constant. Of course, other types of speed control mechanisms may be employed—e.g. the magnetic field within the motor 24, may be controlled such that the speed of the motor changes. In order to control the various functions of the paper cutter 10, a controller 70 is provided—see FIG. 1. The controller 70 is configured to control the operation of the motor 24 and the movement of the saw 60 into the paper roll. In addition, the controller 70 can be configured to control at least some of the other functions of the paper cutter 10.

Another advantage of the paper cutter 10 is that it can be easily produced from a commercially available paper roll stand. Roll stands are available that include a base and a pair of actuators, where the base includes a pair of movable arms. Each of the actuators cooperate with the respective arm for selectively adjusting the height of at least a portion of the respective arm. Typically, these paper stands are not configured with spindles, nor are the actuators set to a predetermined height. Therefore, in order to produce a paper cutter, such as the paper cutter 10, spindles are attached to each of the arms such that the spindles are in general alignment with each other. Each of the spindles are configured to engage a respective end of the horizontally oriented paper roll, such as the paper roll 38 shown in FIG. 3. The maximum extension of each of the actuators is set to a predetermined fixed distance, which facilitates lifting of the paper roll 38 to a predetermined fixed height for cutting. A vertical support, such as the support 58 is provided proximate the base, and a saw, such as the saw 60 is supported on the support 58. Because many roll stands have wheels which are configured to ride in a track, production of a paper cutter, such as the paper cutter 10 may include replacement of such wheels with wheels that will ride on a flat surface, such as a shop floor. Of course, the steps described herein to produce a horizontal paper cutter, such as the paper cutter 10, from a paper roll stand, may need to be varied depending on the type of stand to be modified.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for cutting a horizontally oriented paper roll, the apparatus comprising:
a base including a movable arm;
a spindle configured to cooperate with the arm and to engage an end of the horizontally oriented paper roll, the spindle being operable to rotate the paper roll about a longitudinal axis;
an actuator cooperating with the arm for selectively adjusting the height of the spindle, the actuator being operable to lift the paper roll off a resting surface to position the paper roll for cutting when the spindle is engaged with the paper roll;
a support proximate the base; and
a blade supported by the support and movable in a plane generally perpendicular to the longitudinal axis, the blade being movable into the paper roll for cutting the paper roll.

2. The apparatus of claim 1, further comprising a pair of the movable arms and a pair of the spindles, each of the spindles being attached to a respective arm and generally aligned with the other spindle, each of the spindles being configured to engage a respective end of the paper roll.

3. The apparatus of claim 2, further comprising a pair of the actuators, each of the actuators cooperating with a respective arm for selectively adjusting the height of a respective spindle.

4. The apparatus of claim 3, wherein the support includes a vertical support, and the blade is movable along a length of the vertical support to engage the paper roll.

5. The apparatus of claim 4, wherein the base further includes a rail defining a rail axis, and wherein each of the movable arms includes a first end and a second end, each of the first ends having one of the spindles proximately attached thereto, and each of the second ends cooperating with the rail such that the movable arms pivot about the rail axis when the actuators are actuated, thereby keeping the spindles generally aligned as the height of the spindles is adjusted.

6. The apparatus of claim 5, wherein at least one of the movable arms is linearly movable along the rail, thereby facilitating engagement of the spindles with paper rolls of different lengths.

7. The apparatus of claim 6, further comprising an electric motor operable to rotate one of the spindles, thereby rotating the paper roll about the longitudinal axis when the spindles are engaged with the ends of the paper roll.

8. The apparatus of claim 7, further comprising a controller for controlling at least operation of the motor and the movement of the blade along the vertical support.

9. The apparatus of claim 7, further comprising a speed controller for controlling the speed of the spindle rotated by the motor.

10. The apparatus of claim 9, wherein the speed controller includes a gear set disposed between the motor and the spindle rotated by the motor, the gear set being capable of providing multiple gear ratios to vary the speed of the spindle rotated by the motor.

11. A horizontal paper cutter, comprising:
a base including a pair of movable arms, each of the arms having a spindle attached thereto, each of the spindles being generally aligned with the other spindle and configured to engage a respective end of a horizontally oriented paper roll, at least one of the spindles being operable to rotate the paper roll about a longitudinal axis;
a pair of hydraulic cylinders, each of the cylinders cooperating with a respective arm for selectively adjusting the height of a respective spindle to a predetermined height, the cylinders being operable to lift the paper roll off a resting surface to position the paper roll for cutting when the spindles are engaged with the ends of the paper roll;
a vertical support proximate the base; and
a rotary saw supported by the vertical support and movable along a length of the vertical support, the saw being movable into the paper roll for cutting the paper roll.

12. The paper cutter of claim 11, wherein the base includes a plurality of wheels for facilitating movement of the paper cutter to various locations, thereby eliminating the need to move a paper roll to the paper cutter.

13. The paper cutter of claim 12, wherein the base further includes a rail defining a rail axis, and wherein each of the movable arms includes a first end and a second end, each of the first ends having one of the spindles proximately attached thereto, and each of the second ends cooperating with the rail such that the movable arms pivot about the rail axis when the actuators are actuated, thereby keeping the spindles generally aligned as the height of the spindles is adjusted.

14. The paper cutter of claim 13, wherein at least one of the movable arms is linearly movable along the rail, thereby facilitating engagement of the spindles with paper rolls of different lengths.

15. The paper cutter of claim 14, further comprising an electric motor operable to rotate one of the spindles, thereby rotating the paper roll about the longitudinal axis when the spindles are engaged with the ends of the paper roll.

16. The paper cutter of claim 15, further comprising a controller for controlling at least operation of the motor and the movement of the blade along the vertical support.

17. The paper cutter of claim 15, further comprising a speed controller for controlling the speed of the spindle rotated by the motor.

18. The paper cutter of claim 17, wherein the speed controller includes a gear set disposed between the motor and the spindle rotated by the motor, the gear set being capable of providing multiple gear ratios to vary the speed of the spindle rotated by the motor.

19. A method of producing a horizontal paper cutter from a paper roll stand, the stand including a base and a pair of actuators, the base including a pair of movable arms, each of the actuators cooperating with a respective arm for selectively adjusting the height of at least a portion of the respective arm, the method comprising:
attaching a spindle to each of the arms such that the spindles are in general alignment with each other, each of the spindles being configured to engage a respective end of a horizontally oriented paper roll;
setting a maximum extension of the actuators to a predetermined fixed distance, thereby facilitating lifting of the paper roll to a predetermined fixed height for cutting;
providing a vertical support proximate the base;
supporting a blade on the vertical support such that the blade is movable along a length of the vertical support, thereby facilitating movement of the blade into a paper roll engaged by the spindles.

20. The method of claim 19, further comprising providing a plurality of wheels for the base, thereby facilitating movement of the paper cutter to various locations to eliminate the need to move a paper roll to the paper cutter.
